(19) United States
(12) Patent Application Publication
(10) Pub. No.: US 2014/0304149 A1
(43) Pub. Date: Oct. 9, 2014

(54) INTER-CURRENCY CHEQUE PAYMENT CLEARING

(71) Applicant: The Toronto-Dominion Bank, Mississauga (CA)

(72) Inventors: Mary Hockridge, Burlingame, CA (US); Dino D'Agostino, Richmond Hill (CA); Lauren Van Heerden, Bedford, NH (US)

(21) Appl. No.: 14/246,932

(22) Filed: Apr. 7, 2014

Related U.S. Application Data
(60) Provisional application No. 61/808,900, filed on Apr. 5, 2013.

(51) Int. Cl. G06Q 20/04; G06Q 20/22; G06Q 20/10

(52) U.S. Cl. CPC G06Q 20/042; G06Q 20/10; G06Q 20/22
USPC 705/39

(57) ABSTRACT

A method of cheque payment clearing involves a payee financial institution receiving an electronic representation of a paper cheque. The electronic cheque representation identifies a payment amount, a payor financial institution and a payor account. The payment amount is payable from the payor account in a first currency. The payee institution (i) electronically transmits to the payor institution a transaction origination message identifying a payee account, the payment amount, and an equivalent amount that comprises the payment amount converted to a second currency different from the first currency; (ii) electronically receives from the payor institution a transaction response message identifying a confirmation of a debit entry in the payment amount posted to the payor account and, in accordance with the confirmation, (iii) applies to a payee account a credit entry in the equivalent amount. The equivalent amount is payable from the payee account in the second currency.

### TECHNICAL FIELD

This patent application relates to a computer-based method and network for clearing cheque payments.

### BACKGROUND

To clear a paper cheque payment received from a consumer, a merchant has traditionally been required to deposit the original physical cheque with the merchant's financial institution. The merchant's financial institution would forward the cheque to a financial intermediary, such as the U.S. Federal Reserve Bank, which would then forward the cheque to the consumer's financial institution. Several days after the merchant deposited the cheque with its financial institution, a debit for the specified payment amount would be posted to the consumer's chequing account and a corresponding credit would be posted to the merchant's deposit account.

The ACH (Automated Clearing House) network reduces the time required to clear cheque payments. Instead of depositing a physical cheque with the merchant's financial institution, the merchant uses an electronic cheque scanner and associated software to generate an ACH data file that identifies the merchant's financial institution and deposit account and includes the payment particulars and the MICR (magnetic ink character recognition) information from the consumer's paper cheque (e.g. payment amount, consumer's financial institution and account). After receiving authorization from the consumer, the merchant electronically transmits the ACH data file to the merchant's financial institution. The transaction may be identified in the ACH data file either as a POP (Point of Purchase) entry or a BOC (Back Office Conversion) entry. The merchant's financial institution forwards the ACH data file to the financial intermediary, which then forwards the ACH data file to the consumer's financial institution for posting as a debit entry to the consumer's chequing account.

The United States Check Clearing for the 21^{st} Century (a.k.a “Check21”) Act dispenses with the need to obtain prior authorization from the consumer to electronically process a cheque payment. Instead of generating an ACH data file, the merchant electronically transmits an image of the original paper cheque to its financial institution which, in turn, forwards the cheque image to a financial intermediary that is in close proximity to the consumer's financial institution. The financial intermediary uses the cheque image to generate a paper “substitute cheque” that includes an image depicting all the information that appeared on front and back of the original paper cheque, and all the information that appeared on the MICR line of the paper cheque. Upon receipt of the substitute cheque, the consumer's financial institution posts a debit in the specified payment amount to the consumer's chequing account.

Although the ACH and Check21 networks reduce the time required to clear intra-currency cheque payments (i.e. credits posted in the same currency as that in which the cheques are payable), the Check21 network cannot process inter-currency cheque payments (i.e. credits amounts posted in one financial currency from cheques payable in another (different) financial currency). The ACH network can process inter-currency credit/debit payments as IAT (International ACH transaction) entries. However, the ACH network does not accept outbound inter-currency cheque payments.

### SUMMARY

This document discloses a cheque payment clearing network, cheque processor and associated cheque payment clearing method that can post debit transactions in a first financial currency from cheques made payable in a second financial currency different from the first financial currency.

In accordance with a first aspect of the disclosure, there is provided a method of cheque payment clearing that involves a computer system of a payee financial institution receiving an electronic representation of a paper cheque. The electronic cheque representation identifies at least a payment amount, a payor financial institution and a payor account with the payor financial institution. The payment amount is payable from the payor account in a first financial currency.

The payee financial institution's computer system electronically transmits to a computer system of the payor financial institution via a cheque clearing network a transaction origination message that identifies a payee account of the payee financial institution, the payment amount, and an equivalent amount comprising the payment amount converted to a second financial currency. The second financial currency is different from the first financial currency.

The payee financial institution's computer system electronically receives from the payor financial institution's system via the cheque clearing network a transaction response message that identifies a confirmation of a debit entry in the payment amount posted to the payor account. In accordance with the confirmation, the payee financial institution's system posts to a payee account of the payee financial institution a credit entry in the equivalent amount. The equivalent amount is payable from the payee account in the second financial currency.

In accordance with a second aspect of the disclosure, there is provided a cheque processor that comprises a network interface, a database, and a computer processing system coupled to the network interface and the database. The database maintains a plurality of records each associated with a respective payee account.

The computer processing system is configured to receive an electronic representation of a paper cheque. The electronic cheque representation identifies at least a payment amount, a payor financial institution and a payor account with the payor financial institution. The payment amount is payable from the payor account in a first financial currency.

The computer processing system is also configured to electronically transmit to the payor financial institution via the network interface a transaction origination message identifying a payee account defined in the database, the payment amount, and an equivalent amount comprising the payment amount converted to a second financial currency. The second financial currency is different from the first financial currency.

The computer processing system is further configured to electronically receive from the payor financial institution via the network interface a transaction response message identifying a confirmation of a debit entry in the payment amount posted to the payor account and, in accordance with the confirmation, to post to the payee account a credit entry in the equivalent amount. The equivalent amount is payable from the payee account in the second financial currency.

### BRIEF DESCRIPTION OF THE DRAWINGS

An exemplary cheque payment clearing network, cheque processor and method of cheque payment clearing will now be described, with reference to the accompanying drawings, in which:

FIG. 1 is a schematic view of the cheque payment clearing network, depicting a first financial institution server, a second financial institution server, and a financial intermediary server;

FIG. 2 is a schematic view of the cheque processor hosted by the first the financial institution server; and

FIG. 3 is a message flow diagram depicting the method of cheque payment clearing.

### DETAILED DESCRIPTION OF SPECIFIC EMBODIMENTS

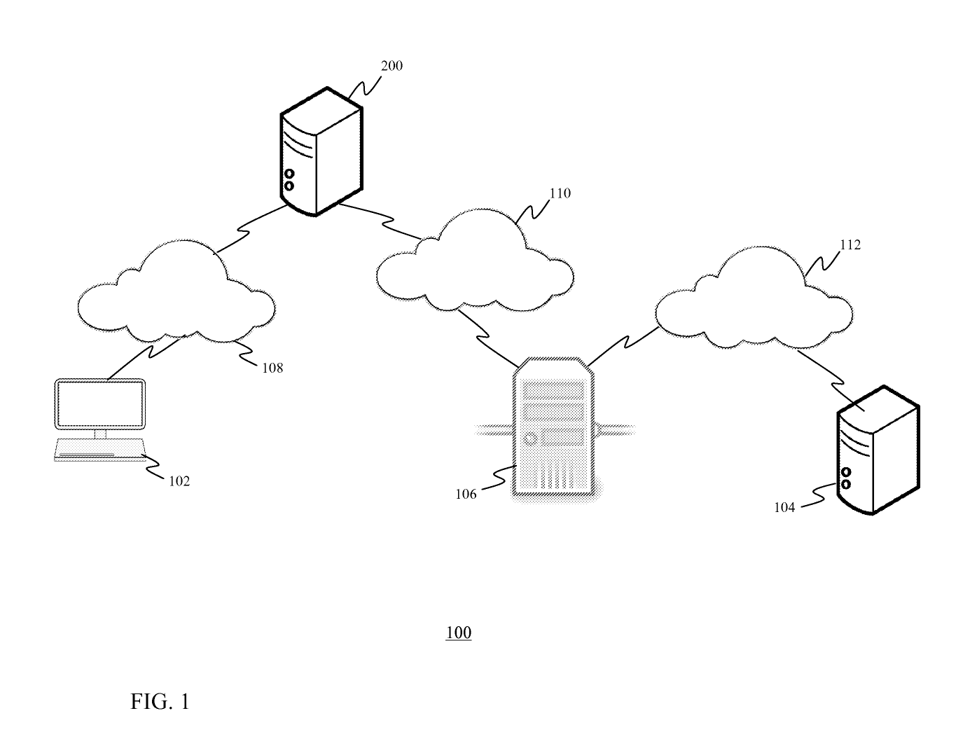

FIG. 1 is a schematic view of a cheque payment clearing network, denoted generally as 100. As shown, the cheque payment clearing network 100 comprises a payment terminal 102, a first financial institution server 200, a second financial institution server 104, a financial intermediary server 106, a first computer network 108, a second computer network 110, and a third computer network 112. Although the cheque payment clearing network 100 is shown comprising only a single payment terminal 102, the payment clearing network 100 typically comprises a plurality of the payment terminals 102.

The financial institution servers 200, 104, and the financial intermediary server 106 are each implemented as conventional computer servers, each of which includes a hardware processor and memory. In some cases, a server 200, 104 may be made up of multiple distinct computers or computing devices that are connected via network. The second financial institution server 104 is typically associated with the financial institution with which the payor of a paper cheque maintains an account to which the cheque can be posted (e.g. chequing account, savings account, credit card, line of credit etc.). The first financial institution server 200 is typically associated with the financial institution with which the payee of the paper cheque maintains an account to which funds can be deposited (e.g. chequing account, savings account, credit card, line of credit etc.). The financial intermediary server 106 is typically associated with a trusted financial intermediary, such as the U.S. Federal Reserve Bank.

The first computer network 108 is preferably implemented as a packet-based network, and facilitates communication between the payment terminal 102 and the first financial institution server 200. The payment terminal 102 is preferably configured with a cheque scanner that can electronically capture particulars of a paper cheque that is presented to the payment terminal 102. The payment terminal 102 is also configured to generate an electronic representation of the paper cheque from the cheque particulars that are captured by the cheque scanner, and to transmit the electronic representation to the first financial institution server 200 via the first computer network 108. As non-limiting examples, the payment terminal 102 may be implemented as a mobile device (e.g. smart phone, digital camera) having photographic and wireless communications capabilities, a computer having a scanner peripheral, a bank teller workstation, an integrated point-of-sale (POS) terminal, an automated teller machine (ATM), or an automated banking machine (ABM).

The cheque scanner of the payment terminal 102 may comprise a MICR-reader that can capture the MICR information from the paper cheque, in which case the electronic representation may comprise an ACH data file that identifies the payee's financial institution, the payee's account with the payee's financial institution, the payment amount specified on the cheque, the financial currency of the payment amount, the payor's financial institution, and the payor's account with the payor's financial institution. Alternately, the cheque scanner may comprise a camera or image capture device that can capture front and back images of the paper cheque, in which case the electronic representation may comprise an ANSI Draft Standard for Trial Use (“DSTU”) X9-compliant data file (or other format accepted by the first financial institution server 200) that includes the cheque images and meta-data that identifies the payee's financial institution, the payment amount specified on the cheque, the financial currency of the payment amount, the payor's financial institution, and the payor's account with the payor's financial institution. In each case, the financial currency of the payment amount corresponds to the financial currency in which funds may be withdrawn from the payor's account.

The second computer network 110 is preferably implemented as a packet-based network, and facilitates communication between the first financial institution server 200 and the financial intermediary server 106. The third computer network 112 is preferably implemented as a packet-based network, and facilitates communication between the second financial institution server 104 and the financial intermediary server 106.

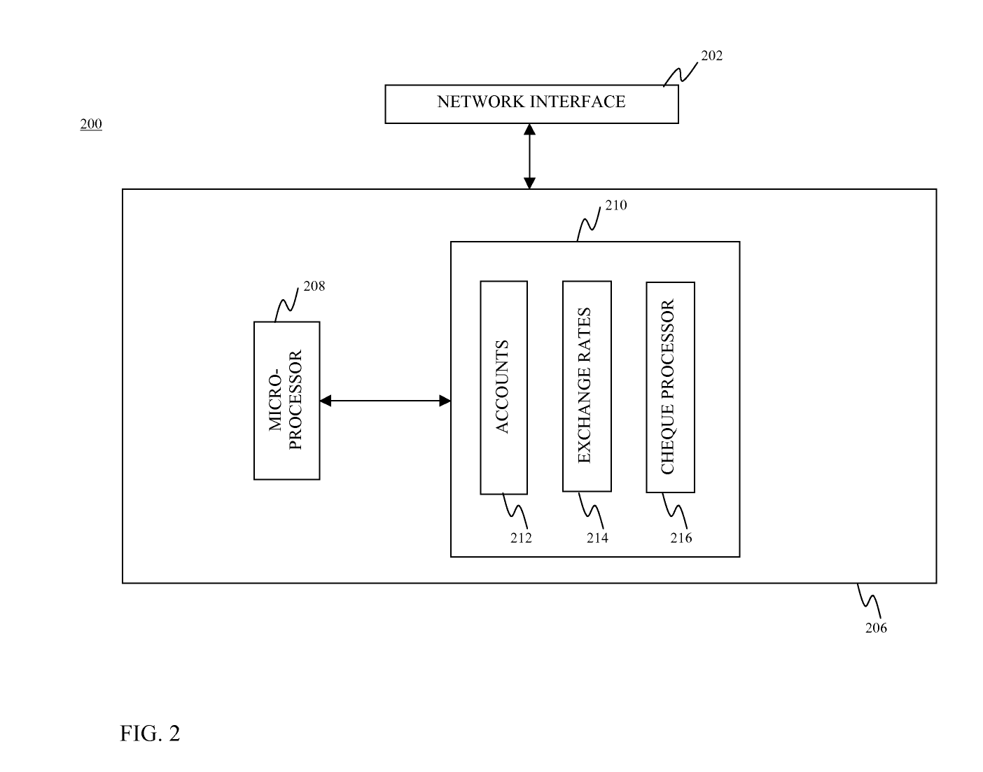

As shown in FIG. 2, the first financial institution server 200 includes a network interface 202, and a computer processing system 206 that is coupled to the network interface 202. The network interface 202 interfaces the first financial institution server 200 with the first computer network 108 and allows the first financial institution server 200 to communicate with the payment terminal(s) 102. The network interface 202 also interfaces the first financial institution server 200 with the second computer network 110 and allows the first financial institution server 200 to communicate with the financial intermediary server 106.

The computer processing system 206 may include one or more microprocessors 208 and a non-transitory computer-readable medium 210. The computer-readable medium 210 may be provided as electronic computer memory (e.g. flash memory) or optical or magnetic memory (e.g. compact disc, hard disk) and may maintain an accounts database 212 that includes a plurality of clusters each associated with a respective payee account. Each cluster typically comprises a plurality of database records, each identifying a credit/deposit entry to the associated account. The computer-readable medium 210 may also maintain an exchange rates database 214 that includes current daily exchange rate data for various currencies. Typically the first financial institution server 200 receives the exchange rates data in real-time, or substantially real-time, from a third party service provider (not shown).

The computer-readable medium 210 may also include computer processing instructions stored thereon which, when executed by the microprocessor(s) 208, define an operating system (not shown) that controls the overall operation of the first financial institution server 200. The computer processing instructions may also implement a cheque processor 216 that processes electronic cheque representations received from the payment terminal(s) 102, and posts corresponding credit entries to the appropriate payee accounts in the accounts database 212. Although the cheque processor 216 is typically implemented as computer processing instructions, all or a portion of the functionality of the cheque processor 216 may be implemented instead in electronics hardware.

The cheque processor 216 is configured to receive from one of the payment terminals 102 the electronic representation of the paper cheque, and to electronically transmit to the second (payor) financial institution 104, via the network interface 202, a transaction origination message that identifies the payee's financial institution, the payee's account (defined in the database 212), the payor's financial institution, the payor's account, the payment amount, and an equivalent amount that comprises the payment amount converted to a second financial currency. The transaction origination message may be provided as an ACH data file, or as a DSTU X9-compliant data file (or other format accepted by the financial intermediary server 106) that includes the images of the paper cheque and associated meta-data.

As discussed, the electronic representation identifies at least the payment amount and a first financial currency. In this embodiment, the first financial currency is the financial currency of the payment amount and corresponds to the financial currency in which funds may be withdrawn from the payor's account, and the second financial currency corresponds to the financial currency in which funds may be deposited to the payee's account. As will be discussed, the first financial currency will typically be different from the second financial currency.

The cheque processor 216 is also configured to electronically receive from the second (payor) financial institution 104 via the network interface 202 a transaction response message identifying a confirmation that a debit entry in the payment amount has been successfully posted to the payor's account and, in accordance with the confirmation, to post to the payee's account a credit entry in the equivalent amount. The equivalent amount is payable from the payee's account in the second financial currency.

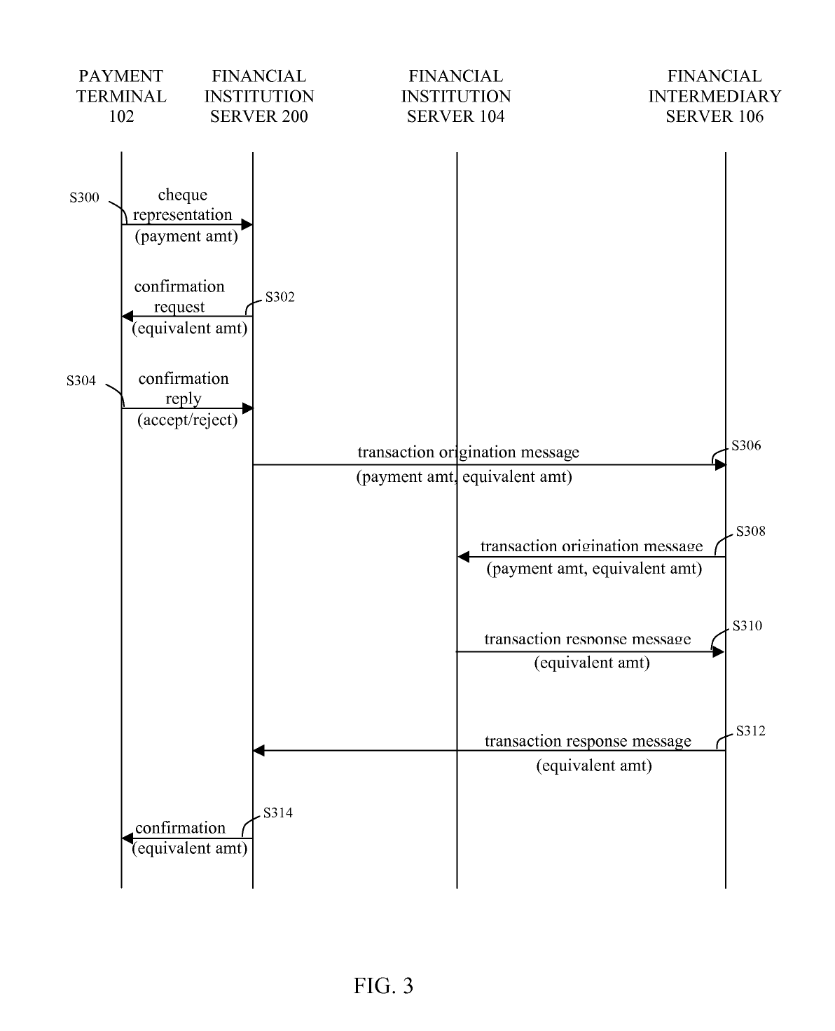

As discussed, the cheque payment clearing network 100 implements a method of clearing cheque payments. A sample embodiment of the cheque clearing method is depicted in FIG. 3. Typically, both the payor and the payee are consumers and the payee consumer uses the clearing network 100 to clear a cheque issued to it by the payor consumer. However, the invention is not limited to this particular affiliation. A business may use the clearing network 100 to clear a cheque issued to it by another business or by a consumer. A consumer may use the clearing network 100 to clear a cheque issued to it by a business.

At the outset of the method, the payor may present the payee with a physical paper cheque as payment for goods and/or services. The paper cheque identifies the name of the payee, the payment amount, the financial currency of the payment amount, and includes a MICR line that identifies the payor's financial institution and the account with the payor's financial institution.

The payment terminal 102 is used to generate an electronic representation of the paper cheque. The electronic representation identifies the payee's financial institution, the payee's account with the payee's financial institution, the payment amount specified on the cheque, the financial currency of the payment amount, the payor's financial institution, and the payor's account with the payor's financial institution. As discussed above, the electronic representation may be provided as an ACH data file, or as meta data together with images of the front and back of the paper cheque. Further, the financial currency of the payment amount corresponds to the financial currency in which funds may be withdrawn from the payor's account. As a non-limiting example, the financial currency in which funds may be withdrawn from the payor's account (the payment amount) may be Canadian dollars, and the financial currency in which funds may be deposited to the payee's account may be U.S. dollars.

At step S300, the payment terminal 102 electronically transmits the electronic representation of the paper cheque to the payee's financial institution server 200 via the first computer network 108. If the (first) financial currency specified in the electronic representation is different from the (second) financial currency in which funds may be deposited to the payee's account, preferably the payee's financial institution server 200 queries the exchange rates database 214 with the first financial currency to locate the current exchange rate between the first financial currency and the second financial currency. The payee's financial institution server 200 uses the payment amount and the located current exchange rate to determine an equivalent amount, expressed in the second financial currency, that is equivalent to the payment amount specified in the electronic representation. Since the exchange rates database 214 is updated with exchange rates data in real-time, or substantially real-time, the equivalent amount comprises the real-time, or substantially real-time, equivalent of the payment amount, converted to the (second) financial currency.

The payee's financial institution server 200 may then transmit a confirmation request message to the payment terminal 102, at step S302, commanding the payment terminal 102 to display the equivalent amount and any applicable service charge and requesting confirmation from the payee that it accepts the equivalent amount and the service charge (if any). In response, at step S304 the payment terminal 102 may transmit a confirmation reply message accepting or refusing the equivalent amount and service charge.

If the confirmation reply message indicates that the payee accepts the equivalent amount and service charge (if any), the payee's financial institution server 200 generates a transaction origination message from the electronic representation of the paper cheque. The transaction origination message typically identifies the financial intermediary server 106, the payee's financial institution and account, the payor's financial institution and account, the payment amount and the equivalent amount. The merchant's (payee) financial institution server 200 then electronically transmits the transaction origination message to the financial intermediary server 106 via the second computer network 110, at step S306. As discussed, the transaction origination message may be provided as an ACH data file, or as a DSTU X9-compliant data file (or other format accepted by the financial intermediary server 106) that includes the images of the paper cheque and associated meta-data.

In one variation, instead of the payee's financial institution server 200 determining the equivalent amount, the payee's financial institution server 200 may periodically download the current exchange rate data to the payment terminal(s) 102. Alternately, the payment terminal 102 identifies the first and second financial currencies when the electronic representation is generated, and transmits a currency request message to the payee's financial institution server 200, requesting the current exchange rate for the identified currencies. In these variations, instead of the payee's financial institution server 200 transmitting a confirmation request message to the payment terminal 102 at step S302, the payment terminal 102 determines and displays the equivalent amount and any applicable service charge when the electronic representation is generated, and requests confirmation of acceptance from the payee. The payment terminal 102 then transmits the electronic representation to the payee's financial institution server 200 at step S300, if the payment terminal 102 receives confirmation that the payee accepts the equivalent amount and service charge (if any). The payee's financial institution server 200 then generates a transaction origination message from the electronic representation, as discussed above, and electronically transmits the transaction origination message to the financial intermediary server 106 via the second computer network 110, at step S306.

Upon receipt of the transaction origination message from the payee's financial institution server 200, the financial intermediary server 106 verifies that the transaction origination message correctly identifies the financial intermediary, determines the payor's financial institution from the transaction origination message, reformats the transaction origination message into a format accepted by the payor's financial institution 104 (if required), and then electronically transmits the (re-formatted) transaction origination message to the payor's financial institution 104 via the third computer network 112, at step S308.

The payor's financial institution server 104 verifies that the transaction origination message correctly identifies the consumer's financial institution, and then determines whether the payor's account, as identified in the transaction origination message, has sufficient funds to process a debit transaction for the payment amount specified in the transaction origination message. If the payor's account does not have sufficient funds for the debit transaction, the payor's financial institution server 104 generates a transaction response message that indicates that the debit transaction was refused. Otherwise, the payor's financial institution server 104 posts a debit entry to the payor's account in the payment amount, and generates a transaction response message that confirms that a debit entry in the payment amount was posted to the payor's account.

The transaction response message typically also identifies the financial intermediary server 106, the payee's financial institution, the payee's account, and the equivalent amount. The payor's financial institution server 104 then electronically transmits the transaction response message to the financial intermediary server 106 via the third computer network 112, at step S310. The financial intermediary server 106 verifies that the transaction response message correctly identifies the financial intermediary, determines the payee's financial institution from the transaction response message, and then electronically transmits the transaction response message to the payee's financial institution server 200 via the second computer network 110, at step S312.

The payee's financial institution server 200 verifies that the transaction response message correctly identifies the merchant's financial institution. If the transaction response message confirms that a debit entry in the payment amount was posted to the payor's account, the payee's financial institution server 200 posts to the payee's account a credit entry in the equivalent amount, less any applicable service charge.

Cheque settlement (steps S306 to S312) may take several days to complete. Accordingly, optionally, at step S314 the payee's financial institution server 200 may electronically transmit to the payment terminal 102, via the first computer network 108, a confirmation message identifying the equivalent amount and any applicable service charge, and indicating that a credit entry in the equivalent amount, less the applicable service charge (if any), was posted to the payee's account.

All of the methods and tasks described herein may be performed and fully automated by a computer system. The computer system may, in some cases, include multiple distinct computers or computing devices (e.g., physical servers, workstations, storage arrays, cloud computing resources, etc.) that communicate and interoperate over a network to perform the described functions. For example, a payor financial institution's server, or a payee financial institutions server may include multiple distinct computers or computing devices that communicate over a network. Each such computing device typically includes a hardware processor (or multiple processors) that executes program instructions or modules stored in a memory or other non-transitory computer-readable storage medium or device (e.g., solid state storage devices, disk drives, etc.). The various functions disclosed herein may be embodied in such program instructions, and/or may be implemented in application-specific circuitry (e.g., ASICs or FPGAs) of the computer system. Where the computer system includes multiple computing devices, these devices may, but need not, be co-located. The results of the disclosed methods and tasks may be persistently stored by transforming physical storage devices, such as solid state memory chips and/or magnetic disks, into a different state. In some embodiments, the computer system may be a cloud-based computing system whose processing resources are shared by multiple distinct business entities or other users.

1. A method of cheque payment clearing, the method comprising:
a payee financial institution server receiving an electronic representation of a paper cheque, the electronic cheque representation identifying at least a payment amount, a payor financial institution and a payor account with the payor financial institution, the payment amount being payable from the payor account in a first financial currency, the payee financial institution server being associated with a payee financial institution;
the payee financial institution server electronically transmitting to a payor financial institution server via a cheque clearing network a transaction origination message identifying a payee account of the payee financial institution, the payment amount, and an equivalent amount comprising the payment amount converted to a second financial currency, the second financial currency being different from the first financial currency, the payor financial institution server being associated with the payor financial institution; and
the payee financial institution server electronically receiving from the payor financial institution server via the cheque clearing network a transaction response message identifying a confirmation of a debit entry in the payment amount posted to the payor account, and in accordance with the confirmation posting to a payee account of the payee financial institution a credit entry in the equivalent amount, the equivalent amount being payable from the payee account in the second financial currency.

2. The method according to claim 1, wherein the payee financial institution server transmitting the transaction origination message comprises the payee financial institution server receiving, from a payee associated with the payee account, confirmation of acceptance of the equivalent amount prior to the payee financial institution server electronically transmitting the transaction origination message to the payor financial institution server.

3. The method according to claim 1, wherein the payee financial institution server receiving an electronic representation comprises a payment terminal receiving confirmation of acceptance of the equivalent amount prior to the payment terminal electronically transmitting the electronic representation to the payee financial institution server.

4. The method according to claim 1, wherein the payee financial institution server receiving an electronic representation comprises a payment terminal receiving confirmation of acceptance of the equivalent amount prior to the payee financial institution server electronically transmitting the transaction origination message to the payor financial institution server.

5. The method according to claim 1, wherein the electronic cheque representation comprises an image of the paper cheque.

6. The method according to claim 1, wherein the transaction origination message comprises an image of the paper cheque.

7. A cheque processor comprising:
a network interface;
a database comprising a plurality of records each associated with a respective payee account;
a computer processing system coupled to the network interface and the database and being configured to:
(i) receive an electronic representation of a paper cheque, the electronic cheque representation identifying at least a payment amount, a payor financial institution and a payor account with the payor financial institution, the payment amount being payable from the payor account in a first financial currency;
(ii) electronically transmit to the payor financial institution via the network interface a transaction origination message identifying a payee account defined in the database, the payment amount, and an equivalent amount comprising the payment amount converted to a second financial currency, the second financial currency being different from the first financial currency; and
(iii) electronically receive from the payor financial institution via the network interface a transaction response message identifying a confirmation of a debit entry in the payment amount posted to the payor account and, in accordance with the confirmation, post to the payee account a credit entry in the equivalent amount, the equivalent amount being payable from the payee account in the second financial currency.

8. The cheque processor according to claim 7, configured to receive, from a payee associated with the payee account, confirmation of acceptance of the equivalent amount prior to transmitting the transaction origination message to the payor financial institution.

9. The cheque processor according to claim 7, configured to receive the electronic representation from a payment terminal after the payment terminal receives confirmation of acceptance of the equivalent amount.

10. The cheque processor according to claim 7, configured to transmit the transaction origination message to the payor financial institution after a payment terminal receives confirmation of acceptance of the equivalent amount.

11. The cheque processor according to claim 7, wherein the electronic cheque representation comprises an image of the paper cheque.

12. The cheque processor according to claim 7, wherein the transaction origination message comprises an image of the paper cheque.

13. A computer readable medium carrying non-transient computer processing instructions stored thereon which, when executed by a computer, cause the computer to perform the method according to claim 1.
